(19) United States
(12) Patent Application Publication
(10) Pub. No.: US 2012/0190340 A1
(43) Pub. Date: Jul. 26, 2012

(54) METHOD FOR BINDING SECURE DEVICE TO A WIRELESS PHONE

(75) Inventors: Ruifeng Li, Beijing (CN); Jing Ouyang, Beijing (CN); Bin Zhang, Beijing (CN); Fang Yang, Beijing (CN)

(73) Assignee: GEMALTO SA, Meudon (FR)

(21) Appl. No.: 13/395,097

(22) PCT Filed: Sep. 8, 2009
(86) PCT No.: PCT/CN2009/001010

§ 371 Date: Apr. 12, 2012

(51) Int. Cl. H04W 12/00; H04W 12/08

(52) U.S. Cl. 455/411; 455/410

(57) ABSTRACT

The present invention provides a method for binding a (smart) secure device (2) to a wireless phone, said wireless phone comprising an identifier parameter, said secure device (2) being adapted to communicate with an Over-The-Air (OTA) server and being suitable for receiving services from a network operator in an authorised area determined with localisation parameters stored in the OTA server, wherein the method comprises the following steps: a. storing the identifier parameter of the wireless phone into the secure device (2) at a first powering on of the wireless phone; b. requesting a user registration on the OTA server so as to download the localisation parameters from the OTA server into the secure device (2). After successful registration confirmation from OTA server, for each powering on, the secure device (2) compares the above two parameters in the secure device (2) with the values from the phone, if they are not the same, authentication is forbidden.

### FIELD OF THE INVENTION

The invention relates to the field of wireless telecommunications.

The invention especially deals with a method for binding a secure device to a wireless phone.

### BACKGROUND OF THE INVENTION

Mobile network operators are interested in proposing diversified offers to their clients. For their business, mobile network operators may propose wireless handsets such as wireless phones which shape looks like that of a fixed phone which is big and not portable. These wireless phones may also connect to the networks using a secure device such as a card, or a USIM card, instead of through a fixed-line for being used in a predetermined area. By doing so, users may pay services fees which are cheaper for these secure devices than those for normal secure devices used in normal mobile phone such as USIM cards.

As the service fee is cheaper with this special secure device, a mobile network that propose this kind of offer, does not want a subscriber to use this secure device on a normal mobile phone to go to anywhere freely. There is then a need to prevent this fraudulent use.

One solution consists in setting same key sets in advance into both the wireless phone and the secure device before issuing. In field use, the wireless phone encrypts random data provided by the secure device and the secure device verifies the encrypted data through a calculation with same keys and an algorithm used by the wireless phone.

The serious disadvantage of this solution is that once the algorithm and the key sets are disclosed, someone can use an attachment on normal mobile phone to simulate a wireless phone process in order to pass the authentication of the secure device. An attachment is for example very thin with a chip on it than can be put between the secure device and the I/O pins (Input/Outputs pins) of the wireless phone in order to detect data between the secure device and the wireless phone. This fraudulent use may be easy once the key sets is disclosed. Furthermore modifying the key sets after the wireless phone issuing for the network operator may be costly and complicated.

Another solution is to change the I/O pins of the secure device and wireless phone but this solution is not efficient as it is easier to bypass by knowing the I/O pins definition.

### SUMMARY OF THE INVENTION

The purpose of the invention is then to provide a solution for preventing someone from using a secure device initially sold for a wireless phone into a normal mobile phone in order to gain much lower charge illegally.

In this purpose, an object of the invention is a method for binding a secure device to a wireless phone, said wireless phone comprising an identifier parameter, said secure device being adapted to communicate with an Over-The-Air (OTA) server and being suitable for receiving services from a network operator in an authorised area determined with localisation parameters stored in the OTA server, wherein the method comprises the following steps:
a. storing the identifier parameter of the wireless phone into the secure device (2) at a first powering on of the wireless phone;
b. requesting a user registration on the OTA server so as to download the localisation parameters from the OTA server into the secure device (2).

According to other aspects of the invention:
the secure device may initiate the user registration on the OTA server and may send the identifier parameter to the OTA server during the powering on of the wireless phone;
if the identifier parameter sent from the secure device has already been recorded in the OTA server, the user registration may be ignored by the OTA server;
the method may comprise a server registration confirmation step in which the OTA server sends a confirmation command to the secure device when the registration is successful and the wireless phone is restarted by an indication from the secure device;
after the server registration confirmation step, at every powering on of the wireless phone, authentication may be processed only if the values of both the identifier parameter and the localisation parameters from the wireless phone are the same as the identifier parameter and the localisation parameters stored in the secure device;
the OTA server may update the localisation parameters through OTA when a user moves to a new authorised area;
the method may comprise a step in which the OTA server checks the localisation parameters and the identifier parameter stored in secure device periodically;
if the information stored in the secure device is different from the information recorded in the OTA server, the OTA server may update the secure device with the information recorded in the server;
each time the secure device is inserted in a handset different from the wireless phone and power on before receiving successful registration confirmation SMS from OTA server, a counter may be launched so as to lock the secure device if the counter value equals a threshold value stored in the secure device;
the method may comprise using the IMEI of the wireless phone as identifier parameter.

The invention also provides a wireless phone comprising an identifier parameter, suitable for receiving a secure device and operating this method.

The identifier parameter from wireless phone, such as the IMEI and the localisation parameters such as the Cell ID assigned by the operator, are two parameters stored in the secure device to limit the user to enjoy lower charge in a restricted area and with a fixed wireless phone.

Thanks to the OTA server, the secure device receives the localisation parameters and the registration confirmation to qualify the identifier parameter from the server. Then the server checks two parameters on the secure device periodically to make sure there is no fraud.

The invention is now described, by way of example, with reference to the accompanying drawings. The specific nature of the following description should not be construed as limiting in any way the broad nature of this summary.

### BRIEF DESCRIPTION OF THE DRAWINGS

In order that the manner in which the above recited and other advantages and features of the invention are obtained, a more particular description of the invention briefly described above will be rendered by reference.

Notwithstanding any other forms that may fall within the scope of the present invention, preferred forms of the invention will now be described, by way of example only, with reference to the accompanying drawing in which:

FIG. 1 schematically shows an embodiment of a method according to the invention.

### DETAILED DESCRIPTION OF THE PREFERRED EMBODIMENTS

The present invention may be understood according to the detailed description provided herein.

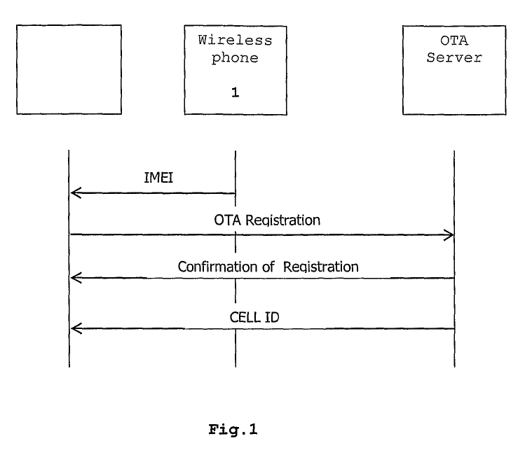

Shown in FIG. 1 is a wireless phone 1 which shape looks like that of a fixed phone. The wireless phone 1 may connect to the networks using a secure device 2, for example a card 2, or a USIM card, instead of through a fixed-line for being used in a predetermined area.

A user may then pay services fees which are cheaper for this secure device 2 than those for example for a normal USIM card used in normal mobile phone. By this way a network operator will be able to sale wireless phone services with low charges to compete with other network operators.

For doing so and forbid someone the use of this secure device 2 in a normal mobile phone, a method according the invention binds the secure device 2 and the telecommunication terminal 1 in which the secure device 2 is inserted, and limits the service area where the subscriber can access to the network.

The network access is limited in a small district or authorised area allowed by the operator's service. This authorised area is determined by localisation parameters, also named Cell ID.

The wireless phone 1 comprises an identifier parameter such as the IMEI (International Mobile Equipment Identity), which is unique for every phone and allows the identification of the wireless phone. The identifier parameter allows the network operator to identify the wireless phone 1 and allows or not the connection.

The wireless phone user is managed by an OTA (Over-The-Air) server.

According to the present method, different steps will now be described.

At a first powering on step of the wireless phone 1, the identifier parameter IMEI is stored into the secure device 2.

Then during the first powering on step, the secure device 2 initiates the user registration on the OTA server and sends the IMEI as identifier parameter to the OTA. Before successful registration, authentication between the secure device 2 and the network is allowed with a threshold time, such as 100 times, to guarantee the registration can be processed successfully. If the IMEI sent from the secure device 2 has already been recorded in the OTA server as successful registered user, the user registration is considered as illegal and then is ignored by the OTA server. Otherwise, the OTA server records the subscriber with the IMEI and downloads available Cell IDs as localisation parameters in which the network access is allowed to the secure device 2. The OTA server sends a confirmation command to the card 2 when the registration is successful.

After successful registration, the wireless phone 1 is restarted by an indication from the secure device 2. This wireless phone 1 is then bind to this unique secure device 2 and is limited to the network access in the authorised area determined by the localisation parameters.

After the server registration confirmation step, at every powering on of the wireless phone 1, authentication can be processed only if the values of both the identifier parameter and the localisation parameter from the wireless phone 1 are the same as the identifier parameter and the localisation parameter stored in the secure device 2. In our example, it means that authentication is processed if the IMEI and the Cell ID from the wireless phone 1 are the same as IMEI and Cell ID stored in the secure device 2. If one of them is not the same, authentication is not passed and the subscriber can not make phone. Indeed, for every wireless phone user, relative Cell ID is allocated to limit the usage area for the user while selling the wireless phone 1 and the secure device 2 to the user. The OTA server gets this information from the operator. After the secure device registers on OTA server with the IMEI, the OTA server finds corresponding Cell ID based on IMEI and sends it to the secure device 2. Then for every powering on later, the secure device compares IMEI and Cell ID with the values from the wireless phone through Provide Local Information command. If these values do not match then authentication is forbidden.

The OTA server and the secure device 2 communicate with security protocol. Except managing user registration, the OTA server also manages localisation parameters for each subscriber.

The method also comprises a step of updating localisation parameter if the subscriber moves to another area as the movement is approved by the operator. Also, if the subscriber moves from the authorised area to a new area also authorised by the network operator, the OTA server updates the localisation parameters through OTA to make sure the user can use the wireless phone 1 in the new authorised area. Indeed, in the case where a user moves from one area to another one, the allowed area for the wireless phone usage is changed. The user should apply the localisation parameters update from the operator. Then the operator updates the relative CELL ID for this user (bind to the IMEI) on the OTA server. After the update on the OTA server, the server updates the CELL ID to the secure device 2 for this user. Finally, the user will be able to use the wireless phone in the new area.

Furthermore in order to prevent any fraudulent use, the method comprises another step in which the OTA server checks the localisation parameters and the identifier parameter stored in secure device periodically, for example each one or two months. It will be well understood that this periodicity in not a limited example and could be configured and manageable by the operator.

If the information stored in the secure device 2 is not the same than the information recorded in the OTA server—i.e. when the IMEI of the secure device 2 is the same than the IMEI on the OTA server, and when the Cell ID in the secure device 2 is different from those in the OTA server—the OTA server updates the secure device 2 with the information recorded in the server.

According to another aspect of the invention, the secure device 2 stores a counter, and a threshold value. Before registration confirmation from the OTA server, the counter is increased for every authentication. Since poor networks situation can exist, it is preferably to allow the secure device 2 to send registration SMS (Short Message Service) for every powering on. When the counter equals the threshold value, what means that someone used the device 2 illegally and shielded the confirmation SMS, the secure device 2 is locked and can not be used anymore after. This has the advantage to limit the type of this fraudulent use.

This method brings advantageously high security provided by a double insurance: the identifier parameter and the localisation parameter allow avoiding fraud.

This method is advantageously simple by providing these two main steps: the step for the first powering on in which the secure device requests the identifier parameter from the wireless phone and stores it, then sends an OTA registration to the server to ask for localisation parameter information; and the main step for every time powering on after receiving the confirmation of successful registration from OTA server, the card compares the IMEI and the Cell ID stored in the card and retrieved from the wireless phone, if they are not the same, authentication is forbidden.

This method also provides a lower possibility for a network operator to be stolen since the OTA server is adopted and since one wireless phone uses an identifier parameter. The fraud cost may be high. And even if it's stolen, the subscriber only can use this secure device in a limited area. Therefore, there is advantageously low possibility for the frauds in commercial operation.

1. A method for binding a secure device (2) to a wireless phone (1), said wireless phone (1) comprising an identifier parameter, said secure device (2) being adapted to communicate with an Over-The-Air (OTA) server and being suitable for receiving services from a network operator in an authorised area determined with localisation parameters stored in the OTA server, wherein the method comprising:
a. storing the identifier parameter of the wireless phone into the secure device (2) at a first powering on of the wireless phone;
b. requesting a user registration on the OTA server so as to download the localisation parameters from the OTA server into the secure device (2).

2. The method according to claim 1 wherein the secure device (2) initiates the user registration on the OTA server and sends the identifier parameter to the OTA server during the powering on of the wireless phone.

3. The method according to claim 2 wherein operating the OTA server to ignore an identifier parameter received from the secure device (2) that has already been recorded in the OTA server.

4. The method according to claim 1 or 2 further comprising a server registration confirmation step in which the OTA server sends a confirmation command to the secure device (2) when the registration is successful and the wireless phone (1) is restarted by an indication from the secure device (2).

5. The method according to claim 3 wherein after the server registration confirmation step, at every powering on of the wireless phone (1), authentication is processed only if the values of both the identifier parameter and the localisation parameters from the wireless phone (1) are the same as the identifier parameter and the localisation parameters stored in the card 2.

6. The method according to claim 1 or 2 wherein the wireless phone is associated with a user and the OTA server updates the localisation parameters through OTA when the user moves to a new authorised area.

7. The method according to claim 1 or 2 further comprising a step in which the OTA server checks the localisation parameters and the identifier parameter stored in secure device (2) periodically.

8. The method according to claim 6 further comprising detecting whether the localization parameters stored in the secure device (2) is different from the localization parameters recorded in the OTA server, and upon determining that the localization parameters stored in the secure device (2) is different, operating the OTA server to update the secure device (2) with the information localization parameters recorded in the server.

9. The method according to claim 1 or 2 wherein each time the secure device (2) is inserted in a handset different from the wireless phone (1) and powered on before receiving successful registration confirmation SMS from the OTA server, a counter is launched so as to lock the secure device (2) if the counter value equals a threshold value stored in the secure device (2).

10. The method according to claim 1 or 2 comprising using the IMEI of the wireless phone as identifier parameter.

11. Wireless phone comprising an identifier parameter, suitable for receiving a secure device (2) operating the method according to one of the preceding claims.

12. A wireless telephone having an identifier parameter and constructed to receive a secure device, the wireless telephone comprising:
a secure device programmed to:
communicate with an Over-The-Aire (OTA) server;
store the identifier parameter of the wireless telephone; and
store a localization parameter received from the OTA server.

13. The wireless telephone of claim 12 wherein the secure device is further programmed to initiate the user registration on the OTA server and sends the identifier parameter to the OTA server during the powering on of the wireless phone.

14. The wireless telephone of claim 13 wherein the secure device is further programmed to receive a registration confirmation message from the OTA server wherein the registration confirmation message is indicative of successful registration of the identifier parameter with the OTA server.

15. The wireless telephone of claim 13 wherein the secure device is further programmed, upon receiving the registration confirmation message, to initiate restart of the wireless telephone.

16. The wireless telephone of claim 13 wherein the secure device is further programmed to authenticate use of the wireless telephone upon detecting a match between the identifier message and the localization parameter.

17. The wireless telephone of claim 13 wherein the wireless telephone is associated with a user and the secure device is further programmed to receive through OTA updated localization parameters from the OTA server when the user of the wireless telephone moves to a new authorized area.

18. The wireless telephone of claim 12 wherein the secure device is further programmed to participate with the OTA server in a periodic check of the localization parameters and identifier parameter stored in the secure device.

19. The wireless telephone of claim 17 wherein the secure device is further programmed to receive from the OTA an update the localization parameters with the localization parameters stored by the OTA server upon the OTA server determining that the localization parameters stored by the OTA server are different from the localization parameters stored by the secure device.

20. The wireless telephone of claim 12 wherein the secure device is further programmed to, upon each time the secure device is inserted in a handset different from the wireless telephone and powered on before receiving successful registration confirmation SMS from the OTA server, launch a counter and to lock the secure device if the counter value equals a threshold value stored in the secure device.

21. The wireless telephone of claim 12 wherein the identifier parameter is the IMEI of the wireless telephone.
